(19) United States
(12) Patent Application Publication
(10) Pub. No.: US 2017/0144733 A1
(43) Pub. Date: May 25, 2017

(54) LIQUEFIED NATURAL GAS STORAGE TANK AND INSULATING WALL SECURING DEVICE FOR LIQUEFIED NATURAL GAS STORAGE TANK

(71) Applicant: DAEWOO SHIPBUILDING & MARINE ENGINEERING CO., LTD., Seoul (KR)

(72) Inventors: Haeng Sung HEO, Seoul (KR); Joong Kyoo KANG, Geoje-si (KR)

(73) Assignee: DAEWOO SHIPBUILDING & MARINE ENGINEERING CO., LTD., Seoul (KR)

(21) Appl. No.: 15/323,940

(22) PCT Filed: Jul. 2, 2015
(86) PCT No.: PCT/KR2015/006812

§ 371 Date: Jan. 4, 2017

(30) Foreign Application Priority Data
Jul. 4, 2014 (KR) 10-2014-0083669
Jul. 4, 2014 (KR) 10-2014-0083671

(51) Int. Cl. B63B 25/16; B63B 17/00; F17C 3/04

(52) U.S. Cl. CPC B63B 25/16; F17C 3/04; B63B 17/0027; F17C 2203/0333; F17C 2203/0631; F17C 2221/033; F17C 2260/011; F17C 2270/0105

(57) ABSTRACT

The present invention relates to: a liquefied natural gas (LNG) storage tank, which has insulating wall securing devices for the LNG storage tank installed at the optimum position, thus is stable with respect to thermal contraction, and may require a minimum number of insulating wall securing devices; and an insulating wall securing device for an LNG storage tank. One embodiment of the present invention provides a storage tank for storing LNG therein, comprising: a first sealing wall coming into contact with the LNG stored in the storage tank, for liquid-tight sealing the LNG; a first insulating wall; a second insulating wall disposed in the inner wall of the storage tank; a plurality of first insulating wall securing devices for securing the first insulating wall and the second insulating wall, wherein the plurality of first insulating wall securing devices are provided at the vertex of the first insulating wall.

### TECHNICAL FIELD

The present invention relates to an liquefied natural gas (LNG) storage tank, and, more particularly, to an LNG storage tank which includes heat insulating wall securing devices at optimal locations to resist thermal shrinkage while minimizing the number of required heat insulating wall securing devices, and a heat insulating wall securing device for an LNG storage tank.

### BACKGROUND ART

Natural gas is a fossil fuel containing methane as a main component and a small amount of ethane and propane and has attracted attention as a low-pollution energy source in various technical fields.

Generally, natural gas is transported through an onshore or offshore gas pipe line in a gaseous state, or to remote sources of demand by an LNG carrier in the form of liquefied natural gas (hereinafter, ‘LNG’). LNG is obtained by cooling natural gas to an extremely low temperature (about −163° C.) and is suitable for long-distance transportation by sea since LNG has a volume of about 1/600 that of natural gas in a gaseous state.

An LNG carrier is equipped with a storage tank (also referred to as ‘cargo tank’) that can store and retain LNG obtained by cooling and liquefying natural gas. Since the boiling point of LNG is about −162° C. at atmospheric pressure, an LNG storage tank may be formed of materials that can withstand ultra-low temperatures, such as aluminum, stainless steel and 35% nickel steel, to safely store and retain LNG and is designed to be resistant to thermal stress and thermal shrinkage and to prevent heat intrusion.

In addition to LNG carriers, LNG RVs (regasification vessels) carrying LNG to an onshore source of demand, regasifying LNG into natural gas, and unloading the natural gas are provided with an LNG storage tank. Recently, floating marine structures such as LNG FPSO (Floating, Production, Storage and Unloading) and LNG FSRU (Floating Storage and Regasification Unit) also include storage tanks installed on LNG carriers or LNG RVs.

An LNG FPSO is a floating marine structure that is used to liquefy produced natural gas at sea and store the liquefied natural gas in a storage tank and to offload the LNG onto an LNG carrier, if necessary. An LNG FSRU is a floating marine structure that is used to store LNG unloaded from an LNG carrier at sea in a storage tank and to regasify the LNG and supply the regasified LNG to onshore sources of demand, if necessary.

As such, offshore structures for transporting or storing liquid cargo such as LNG, such as LNG carriers, LNG RVs, LNG FPSOs, and LNG FSRUs, are provided with a storage tank for storing LNG under cryogenic conditions.

Such a storage tank is divided into an independent-type and a membrane-type depending upon whether the weight of cargo is directly applied to a thermal insulation material. Typically, the membrane-type storage tank is divided into a GTT NO 96-type and a TGZ Mark III-type, and the independent-type storage tank is divided into a MOSS-type and an IHI-SPB-type.

FIG. 1 is a schematic view of a GTT NO 96-type storage tank, which is a conventional LNG storage tank.

Referring to FIG. 1, the GTT NO 96-type storage tank has a structure in which a primary sealing wall 130, a primary heat insulating wall 110, a secondary sealing wall 140, and a secondary heat insulating wall 120 are sequentially stacked. Each of the primary sealing wall 130 and the secondary sealing wall 140 is formed of Invar steel (36% Ni) having a thickness of 0.5 mm to 1.5 mm, and the primary sealing wall and the secondary sealing wall have almost the same liquid tightness and strength. Thus, even when the primary sealing wall leaks, the secondary sealing wall can safely retain a cargo for a considerable period of time. In addition, since a membrane of the sealing wall of the GTT NO 96-type storage tank is linear, the membrane is easier to weld and has a higher rate of automation than a corrugated membrane of a TGZ Mark III-type storage tank, but the overall weld length thereof is longer than that of the membrane of the TGZ Mark III-type storage tank.

The primary heat insulating wall 110 and the secondary heat insulating wall 120 are formed of a plywood box and perlite, and an inner space of each of the heat insulating walls where vertical members 150 formed of plywood are arranged is filled with perlite and nitrogen gas.

FIG. 2 is a schematic view of a TGZ Mark III-type storage tank, which is a conventional LNG storage tank.

Referring to FIG. 2, the TGZ Mark III-type storage tank has a structure in which a primary sealing wall 230, a primary heat insulating wall 210, a secondary sealing wall 240, and a secondary heat insulating wall 220 are stacked. The primary sealing wall 230 is in direct contact with LNG stored in the storage tank and is formed of a stainless steel membrane having a thickness of 1.2 mm, and the secondary sealing wall 240 is formed of triplex.

The primary heat insulating wall 210 and the secondary heat insulating wall 220 are formed of polyurethane foam or the like. Here, the primary heat insulating wall 210, the secondary sealing wall 240 and the secondary heat insulating wall 220 are glued together to secure the primary heat insulating wall 210 to the secondary heat insulating wall 220.

An upper portion of the primary heat insulating wall 210 is placed close to LNG stored at low temperature and undergoes thermal contraction. The TGZ Mark III-type storage tank is not resistant to thermal contraction since the primary heat insulating wall 210 is secured to the secondary heat insulating wall 220 through an adhesive. In addition, use of the adhesive causes difficulties in installation, and the performance of the adhesive may deteriorate over time. Further, there is a problem in the water-tightness performance of the secondary sealing wall 240 since the secondary sealing wall 240 is formed of a composite material.

The GTT NO 96-type storage tank has a disadvantage of high production cost in that the primary sealing wall and secondary sealing wall thereof are formed of expensive Invar steel.

### DISCLOSURE

### Technical Problem

It is an aspect of the present invention to provide an LNG storage tank which is resistant to thermal contraction, can be easily installed and manufactured, can reduce manufacturing costs, and can minimize the number of required heat insulating wall securing devices.

### Technical Solution

In accordance with one aspect of the present invention, there is provided a liquefied natural gas storage tank including: a primary sealing wall contacting liquefied natural gas stored in the storage tank and sealing the storage tank in a liquid-tight manner; a primary heat insulating wall placed under the primary sealing wall and thermally insulating the storage tank; a secondary heat insulating wall disposed on an inner wall of the storage tank and thermally insulating the storage tank; and a heat insulating wall securing device securing the primary heat insulating wall to the secondary heat insulating wall such that the primary heat insulating wall can slide in a horizontal direction.

Particularly, the heat insulating wall securing device may include: a stud bolt secured to the secondary heat insulating wall; and a nut fastened to the stud bolt, and the primary heat insulating wall may be formed with a through-hole, wherein the stud bolt may be inserted into the through-hole and fastened to the nut, such that the primary heat insulating wall is secured to the secondary heat insulating wall.

The heat insulating wall securing device may further include a special washer inserted between a lower plate of the primary heat insulating wall and the nut to prevent the lower plate of the primary heat insulating wall from being separated from the heat insulating wall securing device when the lower plate contracts.

The heat insulating wall securing device may further include a spring washer inserted between the special washer and the nut to prevent the nut from loosening when the lower plate of the primary heat insulating wall is vertically contracted.

An upper plate of the secondary heat insulating wall may be provided with a metal strip, and the stud bolt may be secured to the strip.

The strip may be formed with a first thread, and the stud bolt may be formed with a second thread, such that the first thread is engaged with the second thread to secure the stud bolt to the strip.

The heat insulating wall securing device may further include a spacer surrounding a side surface of the nut to protect the bolt and the nut.

The liquefied natural gas storage tank may further include a secondary sealing wall interposed between the primary heat insulating wall and the secondary heat insulating wall and sealing the storage tank in a liquid-tight manner when the primary sealing wall leaks.

The primary sealing wall and the secondary sealing wall may be formed of stainless steel.

The liquefied natural gas storage tank may further include a plug plugging a hole for installing the heat insulating wall securing device.

In accordance with another aspect of the present invention, there is provided a heat insulating wall securing device for a liquefied natural gas storage tank, which is used to secure a primary heat insulating wall to a secondary heat insulating wall, wherein the heat insulating wall securing device secures the primary heat insulating wall to the secondary heat insulating wall such that the primary heat insulating wall can slide in a horizontal direction, the secondary heat insulating wall is disposed on an inner wall of the storage tank to thermally insulate the storage tank, and the primary heat insulating wall is placed above the secondary heat insulating wall to thermally insulate the storage tank.

Particularly, the heat insulating wall securing device may include: a stud bolt secured to the secondary heat insulating wall; and a nut fastened to the stud bolt, and the primary heat insulating wall may be formed with a through-hole, wherein the stud bolt may be inserted into the through-hole and fastened to the nut, such that the primary heat insulating wall is secured to the secondary heat insulating wall.

The heat insulating wall securing device may further include a special washer inserted between a lower plate of the primary heat insulating wall and the nut to prevent the lower plate of the primary heat insulating wall from being separated from the heat insulating wall securing device when the lower plate contracts.

The heat insulating wall securing device may further include a spring washer inserted between the special washer and the nut to prevent the nut from loosening when the lower plate of the primary heat insulating wall vertically contracts.

An upper plate of the secondary heat insulating wall may be provided with a metal strip, and the stud bolt may be secured to the strip.

The strip may be formed with a first thread, and the stud bolt may be formed with a second thread, such that the first thread is engaged with the second thread to secure the stud bolt to the strip.

The heat insulating wall securing device may further include a spacer surrounding a side surface of the nut to protect the bolt and the nut.

The heat insulating wall securing device may be provided at an apex of the primary heat insulating wall.

In accordance with a further aspect of the present invention, there is provided a liquefied natural gas storage tank including: a primary sealing wall contacting liquefied natural gas stored in the storage tank and sealing the storage tank in a liquid-tight manner; a primary heat insulating wall disposed under the primary sealing wall and thermally insulating the storage tank; a secondary heat insulating wall disposed on an inner wall of the storage tank and thermally insulating the storage tank; and a plurality of first heat insulating wall securing devices securing the primary heat insulating wall to the secondary heat insulating wall, wherein the plural first heat insulating wall securing devices are provided to corners of the primary heat insulating wall.

Particularly, the liquefied natural gas storage tank may further include a plurality of second heat insulating wall securing devices securing the primary heat insulating wall to the secondary heat insulating wall, wherein the plural second heat insulating wall securing devices may be arranged at constant intervals along an edge of the primary heat insulating wall.

The primary heat insulating wall may be secured to the secondary heat insulating wall so as to slide in a horizontal direction.

The heat insulating wall securing device may include: a stud bolt secured to the secondary heat insulating wall; and a nut fastened to the stud bolt, and the primary heat insulating wall may be formed with a through-hole, wherein the stud bolt may be inserted into the through-hole and fastened to the nut, such that the primary heat insulating wall is secured to the secondary heat insulating wall.

The heat insulating wall securing device may further include a special washer inserted between a lower plate of the primary heat insulating wall and the nut to prevent the lower plate of the primary heat insulating wall from being separated from the heat insulating wall securing device when the lower plate contracts.

The heat insulating wall securing device may further include a spring washer inserted between the special washer and the nut to prevent the nut from loosening when the lower plate of the primary heat insulating wall vertically contracts.

An upper plate of the secondary heat insulating wall may be provided with a metal strip, and the stud bolt may be secured to the strip.

The strip may be formed with a first thread, and the stud bolt may be formed with a second thread, such that the first thread is engaged with the second thread to secure the stud bolt to the strip.

The liquefied natural gas storage tank may further include a secondary sealing wall interposed between the primary heat insulating wall and the secondary heat insulating wall and sealing the storage tank in a liquid-tight manner when the primary sealing wall leaks.

The primary sealing wall and the secondary sealing wall may be formed of stainless steel.

Each of the primary sealing wall and the secondary sealing wall may be formed with a corrugated portion.

### Advantageous Effects

According to embodiments of the present invention, a primary heat insulating wall can slide in a horizontal direction and minimize thermal stress upon thermal contraction, whereby an LNG storage tank can be resistant to thermal contraction.

According to embodiments of the present invention, a plug is installed by bolting, whereby installation of the plug is easy, working time can be shortened, and the plug can be held in place securely and stably.

According to embodiments of the present invention, a heat insulating wall securing device is provided at an edge of a primary heat insulating wall, thereby enabling stable fixture of the primary heat insulating wall while minimizing the number of required heat insulating wall securing devices.

### DESCRIPTION OF DRAWINGS

FIG. 1 is a schematic view of a GTT NO 96-type storage tank, which is a conventional LNG storage tank.

FIG. 2 is a schematic view of a TGZ Mark III-type storage tank, which is a conventional LNG storage tank.

FIG. 3 is a sectional view of an exemplary ship having an LNG storage tank according to an embodiment of the present invention.

FIG. 4 is a sectional view of a heat insulating structure of an LNG storage tank according to an embodiment of the present invention.

FIG. 5 is a perspective view of the heat insulating structure of the LNG storage tank according to the embodiment of the present invention.

FIG. 6 is a view illustrating a structure of a heat insulating wall securing device for an LNG storage tank according to an embodiment of the present invention.

FIG. 7 is a view illustrating a method of installing a plug of the heat insulating wall securing device for the LNG storage tank according to the embodiment of the present invention.

FIG. 8 is a view showing the direction in which a primary heat insulating wall thermally contracts.

FIG. 9 is a view showing thermal contraction-induced deformation of a primary heat insulating wall

FIG. 10 is a view showing the position of the heat insulating wall securing device for the LNG storage tank according to the embodiment of the present invention.

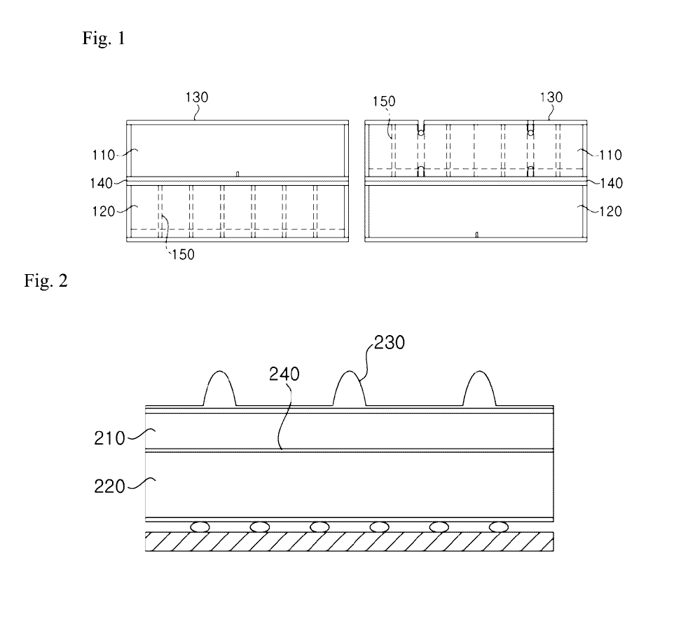

### EMBODIMENTS

Hereinafter, embodiments of the present invention will be described with reference to the accompanying drawings. It should be noted that like components will be denoted by like reference numerals throughout the specification and the accompanying drawings. In addition, descriptions of details apparent to those skilled in the art will be omitted for clarity.

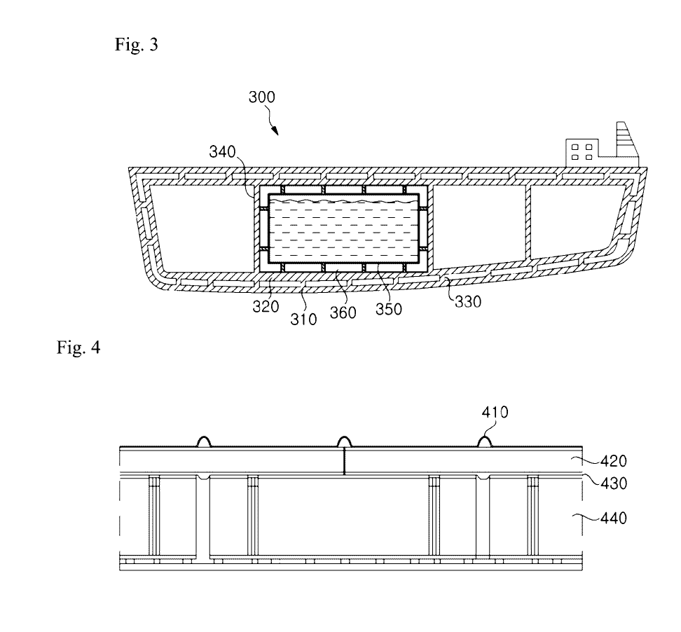

First, a structure of a ship having an LNG storage tank according to an embodiment of the present invention will be described with reference to FIG. 3. FIG. 3 is a sectional view of an exemplary ship having an LNG storage tank according to an embodiment of the present invention.

Referring to FIG. 3, the LNG storage tank according to the embodiment of the present invention may be installed in a ship 300, which is composed of a hull having a double structure of an outer wall 310 forming an outer shape and an inner wall 320 formed inside the outer wall 310. The inner wall 320 and the outer wall 310 of the ship 300 may be connected to each other through a connecting rib 330 to be integrally formed with each other. Alternatively, the ship 300 may be composed of a hull having a single structure without the inner wall 320. In addition, only an upper portion of the ship 300 may be formed as a single deck, and the outer shape of the deck may vary depending on the size or storage capacity of the ship 300.

Further, the interior of the inner wall 320 may be divided by one or more bulkheads 340, which may also form a cofferdam.

A sealing wall 350 seals the storage tank containing LNG in a liquid-tight manner, is in contact with the LNG, and may have a corrugated portion to cope with temperature change caused by loading/unloading of ultra-low temperature LNG.

A heat insulating wall 360 is formed between the sealing wall 350 and the inner wall 320 to thermally insulate the storage tank. The heat insulating wall 360 is composed of a primary heat insulating wall and a secondary heat insulating wall, and the sealing wall may be interposed between the primary heat insulating wall and the secondary heat insulating wall.

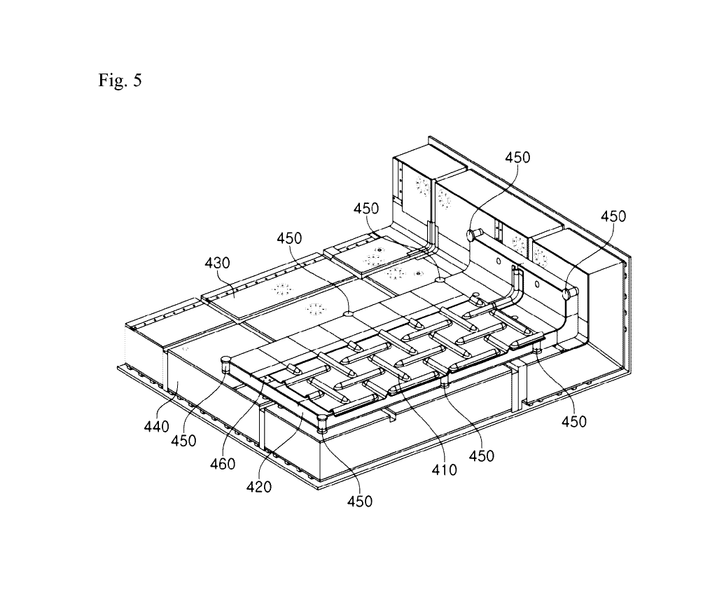

Next, a heat insulating structure of an LNG storage tank according to an embodiment of the present invention will be described with reference to FIGS. 4 and 5. FIG. 4 is a sectional view of a heat insulating structure of an LNG storage tank according to an embodiment of the present invention and FIG. 5 is a perspective view of the heat insulating structure of the LNG storage tank according to the embodiment of the present invention.

Referring to FIGS. 4 and 5, the LNG storage tank according to the embodiment includes a primary sealing wall 410, a primary heat insulating wall 420, a secondary sealing wall 430, a secondary heat insulating wall 440, and a heat insulating wall securing device 450.

The primary sealing wall 410 is disposed on the primary heat insulating wall 420 and seals the storage tank containing LNG in a liquid-tight manner while contacting the LNG.

The secondary sealing wall 430 is interposed between the primary heat insulating wall 420 and the secondary heat insulating wall 440 and serves to seal the storage tank in a liquid-tight manner when the primary sealing wall leaks 410.

A plurality of corrugated portions is formed on both the primary sealing wall 410 and the secondary sealing wall 430 to prevent damage due to shrinkage and elongation caused by temperature change. The corrugated portion expands or contracts due to temperature change caused by loading/unloading of LNG to prevent damage due to thermal deformation of the primary sealing wall 410 and the secondary sealing wall 430. As shown in FIG. 5, the primary sealing wall 410 has a greater number of corrugated portions than the secondary sealing wall 430. This is because the primary sealing wall 410 directly contacts LNG and thus undergoes more expansion or contraction due to temperature change than the secondary sealing wall 430.

Each of the primary sealing wall 410 and the secondary sealing wall 430 may be formed of stainless steel.

The primary heat insulating wall 420 is disposed under the primary sealing wall 410 to thermally insulate the storage tank, and the secondary heat insulating wall 440 is disposed on an inner wall of the LNG storage tank to thermally insulate the storage tank. In other words, the LNG storage tank is disposed on the inner wall thereof with the secondary heat insulating wall 440, and the primary heat insulating wall 420 is disposed above the secondary heat insulating wall 440.

Each of the primary heat insulating wall 420 and the secondary heat insulating wall 440 is composed of an upper plate, a lower plate, and an insulator interposed between the upper plate and the lower plate. The upper plate and the lower plate may be formed of plywood and the insulator may be formed of polyurethane foam.

The primary sealing wall 410, which directly contacts LNG, is disposed on the upper plate of the primary heat insulating wall 420. A metal strip 460 is disposed on the upper plate of the primary heat insulating wall 420 and the primary sealing wall 410 is welded to the strip 460.

The secondary sealing wall 430 is disposed on the upper plate of the secondary heat insulating wall 440. A metal strip is disposed on the upper plate of the secondary heat insulating wall 440 and the secondary sealing wall 430 is welded to the strip 460.

The heat insulating wall securing device 450 serves to secure the primary heat insulating wall 420 to the secondary heat insulating wall 440. Specifically, the heat insulating wall securing device secures the primary heat insulating wall 420 to the secondary heat insulating wall 440 such that the primary heat insulating wall can slide in a horizontal direction.

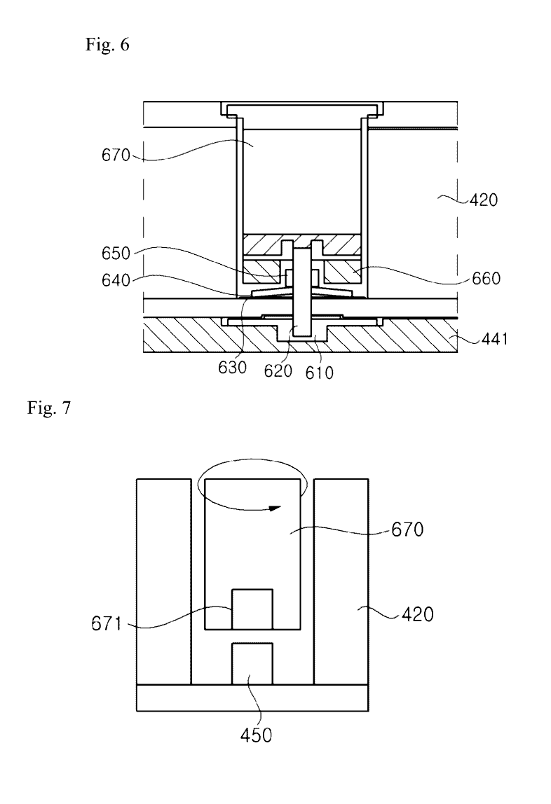

FIG. 6 is a view illustrating a structure of a heat insulating wall securing device for an LNG storage tank according to an embodiment of the present invention, and FIG. 7 is a view illustrating a method of installing a plug of the heat insulating wall securing device for the LNG storage tank according to the embodiment of the present invention.

Referring to FIG. 6, the heat insulating wall securing device 450 includes a stud bolt 620, a special washer 630, a spring washer 640, a nut 650, and a spacer 660.

A metal strip 610 is disposed on the upper plate 441 of the secondary heat insulating wall 440 and the stud bolt 620 is secured to the metal strip. Since threads are formed on the strip 610 and on a lower end portion of the stud bolt 620, the stud bolt 620 is secured to the strip 610 by engaging the thread of the strip 610 with the thread of the stud bolt 620, followed by tightening the bolt.

A through-hole is formed through each of the primary heat insulating wall 420 and the secondary sealing wall 430 at a portion where the heat insulating wall securing device 450 will be installed. When the primary heat insulating wall 420 and the secondary sealing wall 430 are installed on the secondary heat insulating wall 440, the stud bolt 620 is inserted into the through-hole of each of the primary heat insulating wall 420 and the secondary sealing wall 430. Then, after mounting the special washer 630 and the spring washer 640, the nut 650 is fastened to the stud bolt 620 to secure the primary heat insulating wall 420 to the secondary heat insulating wall 440.

The special washer 630 serves to prevent the lower plate of the primary heat insulating wall 420 from being separated from the heat insulating wall securing device 450 even when the lower plate contracts. The special washer 630 has a larger diameter than the nut 650 to secure a large area on which the lower plate of the primary heat insulating wall 420 can slide.

The spring washer 640 can prevent the nut 650 from loosening when the lower plate of the primary heat insulating wall 420 vertically contracts.

After the nut 650 is fastened to the stud bolt 620, the spacer 660 may be mounted. The spacer 660 may have a donut shape surrounding a side surface of the nut and may be formed of plywood. The spacer 650 serves to distribute the load of LNG to protect the bolt and the nut.

The heat insulating wall securing device 450 according to the embodiment of the present invention is configured to allow the lower plate of the primary heat insulating wall 420 to slide between the secondary sealing wall 430 and the special washer 630 such that the primary heat insulating wall 420 can slide in the horizontal direction when undergoing thermal contraction, thereby minimizing thermal stress.

A plug is provided to plug a hole required for mounting the heat insulating wall securing device 450.

As described above, the hole for mounting the heat insulating wall securing device 450 is formed through the primary heat insulating wall. If the hole remains after installation of the heat insulating wall securing device 450 is completed, a cold spot can occur, causing a structural problem in the insulation system of the storage tank and increasing a boil off rate (BOR). In order to solve such a problem, the hole is plugged with the plug 670. After mounting the spacer 660, the plug 670 is securely inserted into the hole. As shown in FIG. 7, a thread 671 is formed on a bottom surface of the plug 670 to be coupled to the stud bolt 620 such that the plug 670 can be bolted to an upper portion of the heat insulating wall securing element 450.

The plug 670 has a cylindrical shape and may include an upper sheet, an insulator, a lower sheet, and a lower cap. The upper sheet and the lower sheet may be formed of plywood and the insulator may be formed of polyurethane foam.

The lower cap is placed under the lower sheet and is composed of a cap portion and a flange radially extending from a lower end of the cap portion. The lower sheet is formed at the center thereof with a hole into which the cap portion of the lower cap is inserted. The cap portion is formed therein with a thread, which will be fastened to the upper portion of the stud bolt 620, such that the plug 670 can be coupled to the heat insulating wall securing device 450.

The plug mounting method according to the embodiment of the embodiment is advantageous in that the method can facilitate installation of the plug, reduce working time, and provide a strong and stable holding force, as compared with a method of installing the plug 670 using adhesives.

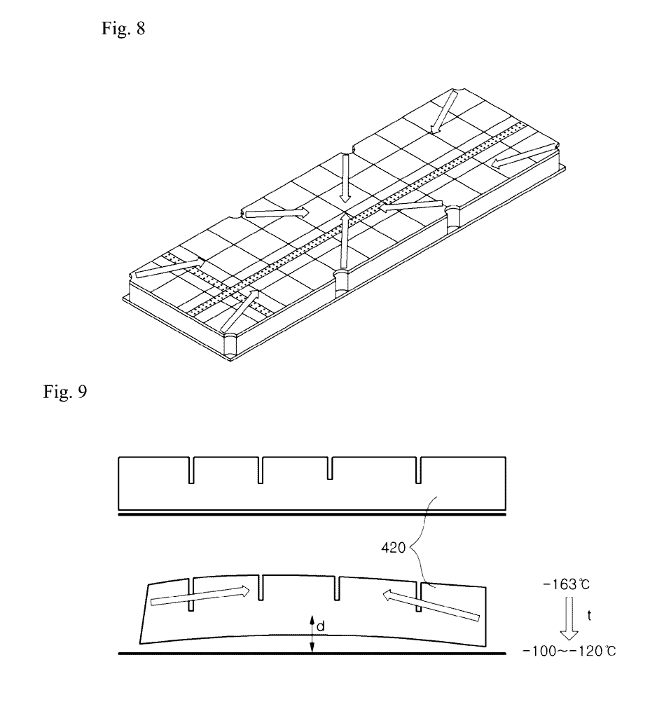

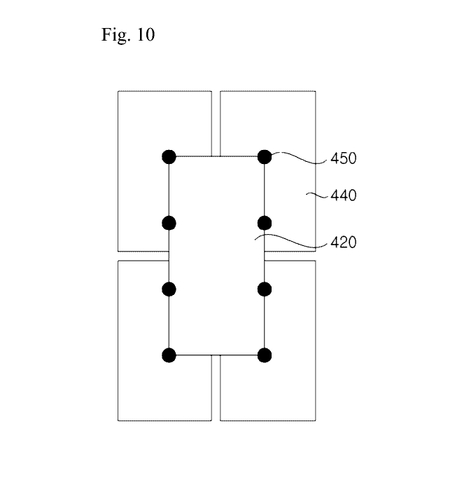

Next, the location of the heat insulating wall securing device for the LNG storage tank according to the embodiment of the invention will be described with reference to FIGS. 8 to 10. FIG. 8 is a view showing the direction in which the primary heat insulating wall thermally contracts, FIG. 9 is a view showing thermal contraction-induced deformation of the primary heat insulating wall, and FIG. 10 is a view showing the location of the heat insulating wall securing device of the LNG storage tank according to the embodiment of the present invention.

When the primary heat insulating wall 420 thermally contracts, the primary heat insulating wall 420 is deformed in various ways depending on the locations of the heat insulating wall securing devices 450. As shown in FIG. 8, the primary heat insulating wall 420 contracts toward the center thereof upon thermal contraction. At an upper side of FIG. 9, there is shown a primary heat insulating wall 420 which is placed at room temperature and is not deformed, and, at a lower side of FIG. 9, there is shown a primary heat insulating wall 420 which is bent upward due to temperature deviation (t) in the thickness direction during carriage of LNG at extremely low temperature, causing a step (d). Such a step (d) can be a structural risk factor of the LNG storage tank when sloshing occurs during transportation of LNG. In order to effectively reduce the step, it is preferable to provide the heat insulating wall securing devices 450 along the edge of the primary heat insulating wall 420.

Thus, as shown in FIG. 10, the heat insulating wall securing device 450 is provided to each corner of the primary heat insulating wall 420. Further, additional heat insulating wall securing devices 450 may be arranged at constant intervals along an edge of the primary heat insulating wall 420. In FIG. 10, the primary heat insulating wall 420 has a size of 1 m×3 m (width×length) and the heat insulating wall securing devices 450 are arranged at an interval of 1 m. Thus, in FIG. 10, a total of eight heat insulating wall securing devices 450 are provided. However, it should be understood that the present invention is not limited thereto and the number of heat insulating wall securing devices 450 may be changed in various ways.

A plurality of primary heat insulating walls 420 can be secured by one heat insulating wall securing device 450 by providing the heat insulating wall securing device 450 to the periphery of the primary heat insulating wall 420, as in the embodiment of the present invention. That is, the heat insulating wall securing device 450 provided to the corner of the primary heat insulating wall 420 can secure four primary heat insulating walls 420, and the heat insulating wall securing device 450 provided to the edge of the primary heat insulating wall 420 can secure two primary heat insulating walls 420. Therefore, according to the embodiment of the invention, the number of heat insulating wall securing devices 450 can be minimized.

Although some embodiments have been described herein, it should be understood by those skilled in the art that these embodiments are given by way of illustration only, and that various modifications, variations and alterations can be made without departing from the spirit and scope of the invention. Therefore, the embodiments disclosed herein should not be construed as limiting the technical scope of the present invention, but should be construed as illustrating the idea of the present invention. The scope of the present invention should be interpreted according to the appended claims and equivalents thereof.

### LIST OF REFERENCE NUMERALS

410: Primary sealing wall

420: Primary heat insulating wall

430: Secondary sealing wall

440: Secondary heat insulating wall

450: Heat insulating wall securing device

460: Strip

620: Stud bolt

630: Special washer

640: Spring washer

650: Nut

660: Spacer

670: Plug

1. A liquefied natural gas storage tank, comprising:
a primary sealing wall contacting liquefied natural gas stored in the storage tank and sealing the storage tank in a liquid-tight manner;
a primary heat insulating wall placed under the primary sealing wall and thermally insulating the storage tank;
a secondary heat insulating wall disposed on an inner wall of the storage tank and thermally insulating the storage tank; and
a heat insulating wall securing device securing the primary heat insulating wall to the secondary heat insulating wall such that the primary heat insulating wall can slide in a horizontal direction.

2. The liquefied natural gas storage tank according to claim 1, wherein the heat insulating wall securing device comprises:
a stud bolt secured to the secondary heat insulating wall; and
a nut fastened to the stud bolt, and
wherein the primary heat insulating wall is formed with a through-hole,
the stud bolt being inserted into the through-hole and fastened to the nut such that the primary heat insulating wall is secured to the secondary heat insulating wall.

3. The liquefied natural gas storage tank according to claim 2, wherein the heat insulating wall securing device further comprises a special washer inserted between a lower plate of the primary heat insulating wall and the nut to prevent the lower plate of the primary heat insulating wall from being separated from the heat insulating wall securing device when the lower plate contracts.

4. The liquefied natural gas storage tank according to claim 3, wherein the heat insulating wall securing device further comprises a spring washer inserted between the special washer and the nut to prevent the nut from loosening when the lower plate of the primary heat insulating wall vertically contracts.

5. The liquefied natural gas storage tank according to claim 2, wherein the heat insulating wall securing device further comprises a spacer surrounding a side surface of the nut to protect the bolt and the nut.

6. The liquefied natural gas storage tank according to claim 1, further comprising:
a secondary sealing wall interposed between the primary heat insulating wall and the secondary heat insulating wall and sealing the storage tank in a liquid-tight manner when the primary sealing wall leaks.

7. A liquefied natural gas storage tank, comprising:
a primary sealing wall contacting liquefied natural gas stored in the storage tank and sealing the storage tank in a liquid-tight manner;
a primary heat insulating wall disposed under the primary sealing wall and thermally insulating the storage tank;
a secondary heat insulating wall disposed on an inner wall of the storage tank and thermally insulating the storage tank; and
a plurality of first heat insulating wall securing devices securing the primary heat insulating wall to the secondary heat insulating wall,
wherein the plural first heat insulating wall securing devices are provided to corners of the primary heat insulating wall.

8. The liquefied natural gas storage tank according to claim 7, further comprising:
a plurality of second heat insulating wall securing devices securing the primary heat insulating wall to the secondary heat insulating wall, the plurality of second heat insulating wall securing devices being arranged at constant intervals along an edge of the primary heat insulating wall.

9. The liquefied natural gas storage tank according to claim 7, wherein the primary heat insulating wall is secured to the secondary heat insulating wall so as to slide in a horizontal direction.

10. The liquefied natural gas storage tank according to claim 8, wherein each of the heat insulating wall securing devices comprises: a stud bolt secured to the secondary heat insulating wall; and a nut fastened to the stud bolt, and
wherein the primary heat insulating wall is formed with a through-hole,
the stud bolt being inserted into the through-hole and fastened to the nut such that the primary heat insulating wall is secured to the secondary heat insulating wall.

11. The liquefied natural gas storage tank according to claim 10, wherein each of the heat insulating wall securing devices further comprises a special washer inserted between a lower plate of the primary heat insulating wall and the nut to prevent the lower plate of the primary heat insulating wall from being separated from the heat insulating wall securing device when the lower plate contracts.

12. The liquefied natural gas storage tank according to claim 11, wherein each of the heat insulating wall securing devices further comprises a spring washer inserted between the special washer and the nut to prevent the nut from loosening when the lower plate of the primary heat insulating wall vertically contracts.

13. The liquefied natural gas storage tank according to claim 7, further comprising: a secondary sealing wall interposed between the primary heat insulating wall and the secondary heat insulating wall and sealing the storage tank in a liquid-tight manner when the primary sealing wall leaks.

14. The liquefied natural gas storage tank according to claim 13, wherein each of the primary sealing wall and the secondary sealing wall is formed of stainless steel.

15. The liquefied natural gas storage tank according to claim 14, wherein each of the primary sealing wall and the secondary sealing wall is formed with a corrugated portion.
